(19) United States
(12) Patent Application Publication
(10) Pub. No.: US 2024/0336817 A1
(43) Pub. Date: Oct. 10, 2024

(54) THREE-COMPONENT POLYURETHANE COMPOSITION HAVING AN ADJUSTABLE POT LIFE

(71) Applicant: SIKA TECHNOLOGY AG, Baar (CH)

(72) Inventors: Thomas SEIFFERT, Schelklingen (DE); Thomas PUSEL, Hemmingen (DE)

(73) Assignee: SIKA TECHNOLOGY AG, Baar (CH)

(21) Appl. No.: 18/575,966

(22) PCT Filed: Aug. 31, 2022
(86) PCT No.: PCT/EP2022/074253

§ 371 Date: Jan. 2, 2024

(30) Foreign Application Priority Data
Sep. 1, 2021 (EP) 21194371.7

(51) Int. Cl. C09J 175/04; C08G 18/24; C08G 18/32; C08G 18/38; C08G 18/48; C08G 18/66; C08G 18/76; C08K 3/34; C08K 3/36; C09J 5/00

(52) U.S. Cl. CPC C09J 175/04; C08G 18/242; C08G 18/3206; C08G 18/3876; C08G 18/4829; C08G 18/6674; C08G 18/7664; C08K 3/34; C08K 3/36; C09J 5/00

(57) ABSTRACT

A three-component polyurethane composition consisting of a first, a second and a third component, the first component containing a polyol having an OH functionality in the range from 1.5 to 4 and an average molecular weight in the range from 250 to 15000 g/mol and a compound having at least one thiol group, the second component containing at least one metal catalyst for the reaction of hydroxyl groups and isocyanate groups, which can form thiol complexes and preferably has a drying agent, and the third component containing at least one polyisocyanate, the molar ratio of all thiol groups of the compound to all metal atoms of the metal catalyst being between 1:1 and 250:1.

### TECHNICAL FIELD

The invention relates to the field of multicomponent polyurethane compositions and to the use thereof, especially as lamination adhesive.

### PRIOR ART

Two-component polyurethane compositions based on polyols and polyisocyanates have already been used for some time. Two-component polyurethane compositions have the advantage over one-component compositions that they cure rapidly after mixing and can therefore absorb and transmit higher forces after just a short time. For use as lamination adhesives, high demands are placed on such compositions in relation to strength and adhesion forces, since such adhesives are used for the production of composite elements, for example sandwich elements, and have to sustain the adhesive integrity of various large-area substrates. In particular, such compositions in the cured state require good mechanical properties such as sufficient strength coupled with suitable moduli of elasticity in order to be able to assure the stability of the composite materials even under thermal or mechanical stress. This is a particular challenge in the case of substrates having different coefficients of thermal expansion. Moreover, the adhesion performance of the adhesive must be sustained over the lifetime of the composite element. Furthermore, it is desirable, for example in industrial manufacture, that such adhesives have a sufficiently long open time for the required large-area application in the production of composite elements, but then cure as quickly as possible, which reduces cycle times. Open times and curing times should additionally be very substantially constant in order to enable automated application.

In order to achieve the desired mechanical properties and above all particularly rapid curing, it is advantageous when such compositions contain high proportions of isocyanates that are present in one of the two components in the form of free or polymer-bound polyisocyanates and that, after mixing with the other component, which contains polyols, cure to form a polymeric network. A high content of isocyanates does however lead to problems. Particularly with the use of crosslinking catalysts, which is essential for selective, optimal crosslinking and curing, such two-component systems become almost uncontrollably fast and pot lives become much too short for use, for example, as a lamination adhesive.

For the use of two-component polyurethane compositions, it would generally be desirable to be able to combine an adequately long pot life with subsequently very rapid curing and extremely rapid hardening. Solutions to this problem have now been found. One such optimized two-component polyurethane composition is disclosed, for example, in WO 2019/002538 A1. The compositions taught in this publication contain specific catalyst systems, in particular bismuth complexes, that are complexed with thiol ligands, and hence enable the desired long, and even adjustable, pot life and thereafter rapid curing, which would make them suitable in principle for use as lamination adhesives.

However, the principle as taught in WO 2019/002538 A1 cannot be applied directly to the application as lamination adhesive. A major problem that occurs specifically in industrial lamination processes is the high sensitivity of the adhesives with regard to relative humidity. This is a particular problem since, in industrial lamination, the adhesives are applied in very thin (for example 100 μm to 1 mm) but large-area (up to several m²) layers, and hence the result is a large interface with ambient air. In the case of relative humidities exceeding 50%, problems occur with large-area, thin-layer lamination applications when the two-component polyurethanes used as adhesives are those that cure the compositions in an uncontrolled manner and form bubbles to some degree and have insufficient adhesion to the substrate layers, or because the catalyst system is deactivated by moisture. Moreover, the storage stability of the two component compositions is often inadequate since catalytic activity changes over the storage time, which leads to faults in the processes specifically in industrial, automated lamination processes with application of adhesive in a thin layer over a large area. Furthermore, the known two-component polyurethane compositions often have inadequate adhesion, especially on metal surfaces.

There is thus a need for a polyurethane-based lamination adhesive that has a comparatively long pot life and open time but nevertheless cures very rapidly, and which has improved storage stability, better adhesion on metal and low sensitivity to high relative humidity.

### SUMMARY OF THE INVENTION

It is therefore an object of the present invention to provide a multicomponent polyurethane composition that cures very rapidly to form a mechanically excellent mass suitable as lamination adhesive, but at the same time has an adequately long pot life and open time which is adjustable within certain limits, allowing it to be processed without problem. Furthermore, the composition is to have improved storage stability, better adhesion on metal and lower sensitivity to high relative humidity, and especially to have a constant pressing time in lamination processes and also to be usable at relative air humidities well above 50%.

This object is surprisingly achieved by the polyurethane composition of the invention as claimed in claim 1. It consists of three individually packaged components that are mixed only before or on application. The first component comprises at least one polyol and a compound having at least one thiol group. The second component comprises at least one metal catalyst for the curing of the composition that can form thio complexes, and preferably at least one desiccant. The third component, finally, comprises at least one polyisocyanate. The composition has excellent storage stability and unexpectedly low sensitivity to high relative humidity, has very high strength and good elasticity in the cured state, and excellent adhesion, especially on metal surfaces. After the components have been mixed, the composition cures very rapidly after an adequately long pot life and open time that is adjustable within certain limits, and achieves very good mechanical values after just a short time, for example a few minutes to a few hours to one day. Furthermore, the composition of the invention can be used in an ideal manner as lamination adhesive and has a constant, low pressing time which is independent of humidity.

Further aspects of the invention are the subject of further independent claims. Particularly preferred embodiments of the invention are the subject of the dependent claims.

### Ways of Executing the Invention

The present invention relates to a polyurethane composition suitable as lamination adhesive, consisting of three components to be mixed on use; wherein
the first component A-1 comprises
   at least one polyol A having an OH functionality in the range from 1.5 to 4 and an average molecular weight (number average) Mₙ in the range from 250 to 15 000 g/mol, and
   at least one compound T that has at least one thiol group; and
the second component A-2 comprises
   at least one metal catalyst K for the reaction of hydroxyl groups and isocyanate groups that can form thio complexes, and
   preferably at least one desiccant; and
the third component B comprises
   at least one polyisocyanate I;
where the molar ratio of all thiol groups in the at least one compound T to all metal atoms in the at least one metal catalyst K is between 1:1 and 250:1.

The prefix “poly” in substance names such as “polyol”, “polyisocyanate”, “polyether” or “polyamine” in the present document indicates that the respective substance formally contains more than one of the functional group that occurs in its name per molecule.

The term “polymer” in the present document encompasses firstly a collective of macromolecules that are chemically uniform, but differ in their degree of polymerization, molar mass, and chain length, said collective having been prepared by a poly reaction (polymerization, polyaddition, polycondensation). The term secondly also encompasses derivatives of such a collective of macromolecules from “poly” reactions, i.e. compounds obtained by reactions, for example additions or substitutions, of functional groups in defined macromolecules and which may be chemically uniform or chemically nonuniform. The term additionally also encompasses what are called prepolymers, i.e. reactive oligomeric preliminary adducts, the functional groups of which are involved in the formation of macromolecules.

The term “polyurethane polymer” encompasses all polymers produced by the so-called diisocyanate polyaddition process. This also includes polymers that are virtually or completely free of urethane groups. Examples of polyurethane polymers are polyether polyurethanes, polyester polyurethanes, polyether polyureas, polyureas, polyester polyureas, polyisocyanurates, and polycarbodiimides.

In the present document, “molecular weight” is understood to mean the molar mass (in grams per mole) of a molecule or a radical of a molecule. “Average molecular weight” refers to the number-average Mₙ of a polydisperse mixture of oligomeric or polymeric molecules or molecular radicals, which is normally determined by gel-permeation chromatography (GPC) against polystyrene as standard. “Room temperature” in the present document refers to a temperature of 23° C. Percent by weight values, abbreviated to % by weight, refer to the proportions by mass of a constituent in a composition based on the overall composition, unless otherwise stated. The terms “mass” and “weight” are used synonymously in the present document.

A “primary hydroxyl group” refers to an OH group bonded to a carbon atom having two hydrogens.

In this document, “pot life” refers to the period within which the polyurethane composition of the invention, after the three components have been mixed, is still liquid and macroscopically homogeneous before the viscosity begins to rise abruptly as a result of the progression of the crosslinking reaction and further application is thus made more difficult or prevented.

In this document, “open time” refers to the period within which the substrates that have been treated with a mixed, applied polyurethane composition according to the present invention have to be joined in order to assure sustained adhesive bonding of these substrates.

In this document, “pressing time” refers to the period required to press two substrates of a composite material together before the curing and buildup of adhesion of the polyurethane composition of the invention that has been applied in between has advanced to such an extent that the bonding has a defined base strength, especially a tensile strength of 1 MPa.

“Room temperature” in the present document refers to a temperature of 23° C. A substance or a composition is described as “storage-stable” or “storable” if it can be stored at room temperature in a suitable container for a relatively long period, typically at least 3 months up to 6 months or longer, without this storage resulting in any change in its application properties or use properties, especially in the viscosity and crosslinking rate, to an extent relevant to its use.

All industry standards and norms mentioned in this document relate to the versions valid at the date of first filing.

### The First Component A-1

The first component A-1 comprises
at least one polyol A having an OH functionality in the range from 1.5 to 4 and an average molecular weight (number average) Mₙ in the range from 250 to 15 000 g/mol, and
at least one compound T having at least one thiol group.

The first component A-1 comprises firstly at least one polyol A having an OH functionality in the range from 1.5 to 4 and an average molecular weight in the range from 250 to 15 000 g/mol.

Suitable polyols A are in principle all polyols currently used in the production of polyurethane polymers. Particularly suitable are polyether polyols, polyester polyols, poly(meth)acrylate polyols, polybutadiene polyols, polycarbonate polyols, and mixtures of these polyols.

Suitable polyether polyols, also known as polyoxyalkylene polyols or oligoetherols, are in particular those that are polymerization products of ethylene oxide, 1,2-propylene oxide, 1,2- or 2,3-butylene oxide, oxetane, tetrahydrofuran or mixtures thereof, optionally polymerized with the aid of a starter molecule having two or more active hydrogen atoms such as water, ammonia or compounds having a plurality of OH or NH groups, for example ethane-1,2-diol, propane-1,2-diol and -1,3-diol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, cyclohexane-1,3-dimethanol and -1,4-dimethanol, bisphenol A, hydrogenated bisphenol A, 1,1,1-trimethylolethane, 1,1,1-trimethylolpropane, glycerol, aniline, and mixtures of the compounds mentioned. It is possible to use either polyoxyalkylene polyols having a low degree of unsaturation (measured in accordance with ASTM D-2849-69 and expressed in milliequivalents of unsaturation per gram of polyol (meq/g)), produced for example using so-called double metal cyanide complex catalysts (DMC catalysts), or polyoxyalkylene polyols having a relatively high degree of unsaturation, produced for example using anionic catalysts such as NaOH, KOH, CsOH or alkali metal alkoxides. Particularly suitable are polyoxyethylene polyols and polyoxypropylene polyols, in particular polyoxyethylene diols, polyoxypropylene diols, polyoxyethylene triols, and polyoxypropylene triols. Preference is given to polyoxyethylene triols and polyoxypropylene triols, especially polyoxypropylene triols. Especially suitable are polyoxyalkylene diols or polyoxyalkylene triols having a degree of unsaturation lower than 0.02 meq/g and having a molecular weight within a range from 1000 to 15 000 g/mol, as are polyoxyethylene diols, polyoxyethylene triols, polyoxypropylene diols, and polyoxypropylene triols having a molecular weight of 400 to 15 000 g/mol.

Likewise particularly suitable are so-called ethylene oxide-terminated (“EO-endcapped”, ethylene oxide-endcapped) polyoxypropylene polyols. The latter are special polyoxypropylene polyoxyethylene polyols that are obtained for example when pure polyoxypropylene polyols, especially polyoxypropylene diols and triols, are at the end of the polypropoxylation reaction further alkoxylated with ethylene oxide and thus have primary hydroxyl groups. Preference in this case is given to polyoxypropylene polyoxyethylene diols and polyoxypropylene polyoxyethylene triols, especially polyoxypropylene polyoxyethylene triols.

Also suitable are hydroxyl-terminated polybutadiene polyols, for example those produced by polymerization of 1,3-butadiene and allyl alcohol or by oxidation of polybutadiene and also the hydrogenation products thereof.

Also suitable are styrene-acrylonitrile grafted polyether polyols such as those commercially available for example under the trade name Lupranol® from Elastogran GmbH, Germany.

Suitable polyester polyols include in particular polyesters that bear at least two hydroxyl groups and are produced by known processes, especially polycondensation of hydroxycarboxylic acids or polycondensation of aliphatic and/or aromatic polycarboxylic acids with dihydric or polyhydric alcohols. Especially suitable are polyester polyols produced from dihydric to trihydric alcohols such as ethane-1,2-diol, diethylene glycol, propane-1,2-diol, dipropylene glycol, butane-1,4-diol, pentane-1,5-diol, hexane-1,6-diol, neopentyl glycol, glycerol, 1,1,1-trimethylolpropane or mixtures of the abovementioned alcohols with organic dicarboxylic acids or the anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride or mixtures of the abovementioned acids, as are polyester polyols formed from lactones such as ε-caprolactone.

Particularly suitable are polyester diols, in particular those produced from adipic acid, azelaic acid, sebacic acid, dodecanedicarboxylic acid, dimer fatty acid, phthalic acid, isophthalic acid and terephthalic acid as the dicarboxylic acid or from lactones such as ε-caprolactone and from ethylene glycol, diethylene glycol, neopentyl glycol, butane-1,4-diol, hexane-1,6-diol, dimer fatty acid diol, and cyclohexane-1,4-dimethanol as the dihydric alcohol.

Suitable polycarbonate polyols include in particular those obtainable by reaction for example of the abovementioned alcohols used to form the polyester polyols with dialkyl carbonates such as dimethyl carbonate, diaryl carbonates such as diphenyl carbonate, or phosgene. Likewise suitable are polycarbonates obtainable from the copolymerization of CO₂ with epoxides such as ethylene oxide and propylene oxide. Polycarbonate diols, in particular amorphous polycarbonate diols, are particularly suitable.

Further suitable polyols are poly(meth)acrylate polyols.

Also suitable are polyhydroxy-functional fats and oils, for example natural fats and oils, in particular castor oil, or so-called oleochemical polyols obtained by chemical modification of natural fats and oils, the epoxy polyesters or epoxy polyethers obtained for example by epoxidation of unsaturated oils and subsequent ring opening with carboxylic acids or alcohols respectively, or polyols obtained by hydroformylation and hydrogenation of unsaturated oils. Also suitable are polyols obtained from natural fats and oils by degradation processes such as alcoholysis or ozonolysis and subsequent chemical linking, for example by transesterification or dimerization, of the thus obtained degradation products or derivatives thereof. Suitable degradation products of natural fats and oils are especially fatty acids and fatty alcohols, and also fatty acid esters, especially the methyl esters (FAME), which can be derivatized, for example, by hydroformylation and hydrogenation to give hydroxy fatty acid esters.

Likewise suitable are, in addition, polyhydrocarbon polyols, also referred to as oligohydrocarbonols, for example polyhydroxy-functional ethylene-propylene, ethylene-butylene or ethylene-propylene-diene copolymers, for example those produced by Kraton Polymers, USA, or polyhydroxy-functional copolymers of dienes, such as 1,3-butadiene or diene mixtures, and vinyl monomers such as styrene, acrylonitrile or isobutylene, or polyhydroxy-functional polybutadiene polyols, for example those which are produced by copolymerization of 1,3-butadiene and allyl alcohol and which may also be hydrogenated.

Also suitable are polyhydroxy-functional acrylonitrile/butadiene copolymers, such as those that can be produced from epoxides or amino alcohols and carboxyl-terminated acrylonitrile/butadiene copolymers, which are commercially available under the name Hypro® (formerly Hycar®) CTBN from Emerald Performance Materials, LLC, USA.

All the polyols mentioned have an average molecular weight of 250 to 15 000 g/mol, in particular of 400 to 10 000 g/mol, preferably of 750 to 7500 g/mol, most preferably of 1000 to 5000 g/mol, and an average OH functionality in the range from 1.5 to 4, preferably 1.7 to 3.5, most preferably 2.0 to 3.0. However, it is entirely possible for the composition to also include proportions of monools (polymers having only one hydroxyl group).

Particularly suitable polyols are polyether polyols, in particular polyoxyethylene polyol, polyoxypropylene polyol, and polyoxypropylene polyoxyethylene polyol, preferably polyoxyethylene diol, polyoxypropylene diol, polyoxyethylene triol, polyoxypropylene triol, polyoxypropylene polyoxyethylene diol, and polyoxypropylene polyoxyethylene triol. Of all the polyols mentioned, the respective triols are particularly preferred.

In preferred embodiments of the polyurethane composition the polyol A comprises at least one polyether triol.

The first component A-1 may further contain at least one diol having two hydroxyl groups that are linked via a C2 to C9 carbon chain.

Especially suitable diols are selected from the group consisting of ethylene glycol, propane-1,3-diol, butane-1,4-diol, pentane-1,5-diol, hexane-1,6-diol, heptane-1,7-diol, octane-1,8-diol, nonane-1,9-diol, butane-1,3-diol, butane-2,3-diol, 2-methylpropane-1,3-diol, pentane-1,2-diol, pentane-2,4-diol, 2-methylbutane-1,4-diol, 2,2-dimethylpropane-1,3-diol (neopentyl glycol), hexane-1,2-diol, butane-1,4-diol, 3-methylpentane-1,5-diol, octane-1,2-diol, octane-3,6-diol, 2-ethylhexane-1,3-diol, 2,2,4-trimethylpentane-1,3-diol, 2-butyl-2-ethylpropane-1,3-diol, 2,7-dimethyloctane-3,6-diol, cyclohexane-1,4-diol, cyclohexane-1,3-dimethanol, and cyclohexane-1,4-dimethanol.

Particular preference is given to diols selected from the group consisting of butane-1,4-diol, pentane-1,5-diol, hexane-1,6-diol, heptane-1,7-diol, octane-1,8-diol, and nonane-1,9-diol.

These diols are commercially readily available and provide polyurethanes having particularly high moduli of elasticity at low elongation when cured.

In addition to these polyols A mentioned and the diols mentioned, it is possible to include small amounts of further low molecular weight dihydric or polyhydric alcohols such as diethylene glycol, triethylene glycol, the isomeric dipropylene glycols and tripropylene glycols, the isomeric decanediols and undecanediols, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low molecular weight alkoxylation products of the abovementioned dihydric and polyhydric alcohols, and mixtures of the aforementioned alcohols. In addition, polyols containing other heteroatoms, for example methyldiethanolamine or thiodiglycol, may also be present.

Component A-1 contains preferably 20% to 75% by weight, preferably 25% to 60% by weight, especially 30% to 50% by weight, of polyol A, based on component A-1.

The first component A-1 further comprises at least one compound T that has at least one thiol group. Suitable are all compounds having at least one thiol or mercapto group that are able to be formulated into the composition of the invention. A thiol group is understood here as meaning an —SH group that is attached to an organic radical, for example an aliphatic, cycloaliphatic or aromatic carbon radical.

Preference is given to compounds having 1 to 6, especially 1 to 4, most preferably 1 or 2 thiol groups. Compounds having a thiol group have the advantage that they do not form complexes with the metal catalyst K, which tend to be sparingly soluble, and that pot life and open time can be adjusted particularly accurately. Compounds having two thiol groups have the advantage that the mechanical properties of the composition when cured are improved.

Examples of suitable compounds T having a thiol group are 3-mercaptopropyltrimethoxysilane, 3-mercaptopropyltriethoxysilane, 3-mercaptopropane-1,2-diol, 2-mercaptotoluimidazole or 2-mercaptobenzothiazole.

Examples of suitable compounds T having more than one thiol group are ethylene glycol di(3-mercaptopropionate), ethylene glycol dimercaptoacetate, trimethylolpropane tri(3-mercaptopropionate), dipentaerythritol hexa(3-mercaptopropionate), 2,3-dimercapto-1,3,4-thiadiazole or pentaerythritol tetrakis(3-mercaptopropionate).

The compound T is preferably selected from the group consisting of ethylene glycol di(3-mercaptopropionate), ethylene glycol dimercaptoacetate, dipentaerythritol hexa(3-mercaptopropionate), trimethylolpropane tri(3-mercaptopropionate) and 3-mercaptopropyl trimethoxysilane. Most preferred is trimethylolpropane tri(3-mercaptopropionate).

The molar ratio of all the thiol groups in the at least one compound T to all metal atoms in the at least one metal catalyst K must be between 1:1 and 250:1. It is preferably between 2:1 and 150:1, especially between 5:1 and 100:1. This quantitative ratio allows the pot life to be adjusted, specifically within the intrinsic limits of the particular composition, through, for example, the content of catalyst, the reactivity of the isocyanates present, and the amount thereof. The lower limit of the pot life is the pot life that is obtained in a given composition when using a defined amount of catalyst without addition of compound T. In many cases where the inventive application as lamination adhesive is suitable, and as a consequence of the large number of isocyanate groups in the presence of a catalyst but without compound T, no actual pot life at all is achieved, and the composition starts to cure almost immediately when the two components are mixed.

The upper limit of the adjustable pot life and open time is accordingly that pot life or open time which would be achieved as a result of the uncatalyzed isocyanate-hydroxyl reaction without use of a catalyst. Even without the use of a catalyst, this reaction will commence at some point after the two components have been mixed. However, the reaction without catalyst proceeds much more slowly and with development of poorer mechanical and other properties in the cured material.

The key advantage achieved by the three-component polyurethane composition of the invention is a system that cures and builds up strength with extraordinary rapidity, while at the same time having an adequately long pot life and open time that allows it to be processed in a user-friendly manner. Furthermore, the pressing time required is nevertheless very short in the case of composite materials and in particular is not prone to fluctuating humidity. This means, for example, that bonding can be carried out on relatively large substrates too, which can already be processed further or transported very shortly after the application of the adhesive and brief pressing of the substrates. This results, for example, in a significant shortening of cycle times in industrial manufacture. A further advantage of the polyurethane compositions of the invention is the possibility of being able to adjust the pot life and open time as described above. This is very advantageous particularly in automated applications and can for example allow further optimization of cycle times in industrial production, since the pot life and open time can be tailored to the desired use.

Component A-1 preferably contains 1% to 5% by weight, preferably 1.25% to 4% by weight, especially 1.5% to 3.5% by weight, of compound T that has at least one thiol group, based on the overall first component A-1.

Component A-1 may also contain further, optional constituents. These are set out in detail further down.

A preferred first component A-1 contains, based in each case on the overall component A-1,
15% to 65% by weight, preferably 20% to 50% by weight, in particular 25% to 40% by weight, of polyol A,
1% to 5% by weight, preferably 1.25% to 4% by weight, especially 1.5% to 3.5% by weight, of a compound T having at least one thiol group, and
15% to 80% by weight, preferably 25% to 75% by weight, especially 50% to 70% by weight, of fillers,
and optionally further constituents.

### The Second Component A-2

The second component A-2 comprises
at least one metal catalyst K for the reaction of hydroxyl groups and isocyanate groups that can form thio complexes, and
preferably at least one desiccant.

The second component A-2 firstly contains at least one metal catalyst K for the reaction of hydroxyl groups and isocyanate groups that can form thio complexes. Suitable metal catalysts K are thus all metal catalysts that can be used as a crosslinking catalyst in polyurethane chemistry and can at the same time form thio complexes with thiols in the presence thereof.

The metal catalyst K is present solely in the second component A-2. This has the advantage of achieving better storage stability.

Examples of suitable metal catalysts are compounds of bismuth, zinc, tin, iron or zirconium, including complexes and salts of these metals. Preference is given to a bismuth(III), zinc(II), zirconium(IV) or tin(II) compound or an organotin(IV) compound. Most preferred are organotin(IV) compounds since these have particularly high activity but are the least sensitive to moisture. The metal catalyst K preferably includes an organotin compound, especially organotin(IV) compound.

The tin compound used may be any of a multitude of conventional tin catalysts. Particularly suitable organotin compounds are dialkyltin oxides, dialkyltin dichlorides, dialkyltin dicarboxylates, and dialkyltin diketonates, especially dibutyltin oxide, dibutyltin dichloride, dibutyltin diacetate, dibutyltin dilaurate, dibutyltin diacetylacetonate, dioctyltin oxide, dioctyltin dichloride, dioctyltin diacetate, dioctyltin dilaurate or dioctyltin diacetylacetonate, or alkyltin thioesters.

In a very preferred embodiment, the metal catalyst K is a dioctyltin dicarboxylate, especially dioctyltin dilaurate.

Component A-2 contains preferably 0.05% to 1.0% by weight, preferably 0.1% to 0.75% by weight, especially 0.15% to 0.5% by weight, of metal catalyst K, based on the second component A-2.

The second component A-2 preferably further comprises at least one desiccant. Such a desiccant increases storage stability and is advantageous especially in the case of large-area lamination bonds.

Suitable desiccants are all chemical or physical desiccants that are used customarily in polyurethane chemistry.

The following are especially suitable: reactive silanes, such as tetraethoxysilane, vinyltrimethoxysilane, vinyltriethoxysilane or organoalkoxysilanes which have a functional group in the a position to the silane group, especially N-(methyldimethoxysilylmethyl)-O-methylcarbamate, (methacryloyloxymethyl)silanes, methoxymethylsilanes, molecular sieve powders, calcium oxide, highly reactive isocyanates such as p-tosyl isocyanate, monomeric diisocyanates, monooxazolidines such as Incozole 2 (from Incorez), or orthoformic esters.

Preferred desiccants are molecular sieves, especially in fine powder form.

Component A-2 contains preferably 0.1% to 20% by weight, preferably 1% to 15% by weight, especially 5% to 12% by weight, of desiccant, based on the second component A-2.

Component A-2 may also contain further, optional constituents. These are set out in detail further down.

In preferred embodiments of the three-component polyurethane composition according to the present invention, the second component A-2 additionally includes at least one polyol A.

This offers the advantage that the miscibility of the two components A-1 and A-2 is improved and/or that the mixing ratios can thus be adjusted as required. In respect of the polyol A that may be present in the second component A-2, the same details are applicable as described above for component A-1. It is possible for an identical or different polyol A to be present in component A-2 and component A-1, and is also possible for identical and different mixtures of polyols A to be present in one of the two components A-1 and A-2 or in both components.

If polyols A are present in the second component A-2, they are preferably present in an amount of 20% to 75% by weight, preferably 25% to 60% by weight, especially 30% to 50% by weight, of polyol A, based on component A-2.

A preferred embodiment of a second component A-2 contains, based in each case on the overall component A-2,
20% to 75% by weight, preferably 25% to 60% by weight, in particular 30% to 50% by weight, of polyol A,
0.05% to 1.0% by weight, preferably 0.1% to 0.75% by weight, especially 0.15% to 0.5% by weight, of metal catalyst K,
0.1% to 20% by weight, preferably 1% to 15% by weight, especially 5% to 12% by weight, of desiccant, and
10% to 75% by weight, preferably 25% to 70% by weight, especially 35% to 60% by weight, of fillers,
and optionally further constituents.

### The Third Component B

The third component B firstly contains at least one polyisocyanate I.

The polyisocyanate I is present in relatively high amounts, which is very advantageous for the development of mechanical properties that are good enough for use as a lamination adhesive.

The third component preferably contains sufficient polyisocyanate I for there to be at least 5% by weight, especially at least 6% by weight, preferably at least 7.5% by weight, of isocyanate groups based on the overall polyurethane composition.

Polyisocyanates I used may be any of the conventional polyisocyanates, especially diisocyanate, that are suitable for polyurethane production.

Suitable polyisocyanates are in particular monomeric di- or triisocyanates and also oligomers, polymers, and derivatives of monomeric di- or triisocyanates, and any desired mixtures thereof.

Suitable aromatic monomeric di- or triisocyanates are especially tolylene 2,4- and 2,6-diisocyanate and any desired mixtures of these isomers (TDI), diphenylmethane 4,4′-, 2,4′-, and 2,2′-diisocyanate and any desired mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), 1,3,5-tris(isocyanatomethyl)benzene, tris(4-isocyanatophenyl)methane, and tris(4-isocyanatophenyl) thiophosphate.

Suitable aliphatic monomeric di- or triisocyanates are in particular tetramethylene 1,4-diisocyanate, 2-methylpentamethylene 1,5-diisocyanate, hexamethylene 1,6-diisocyanate (HDI), 2,2,4- and 2,4,4-trimethylhexamethylene 1,6-diisocyanate (TMDI), decamethylene 1,10-diisocyanate, dodecamethylene 1,12-diisocyanate, lysine diisocyanate and lysine ester diisocyanate, cyclohexane 1,3- and 1,4-diisocyanate, 1-methyl-2,4-and -2,6-diisocyanatocyclohexane and any mixtures of these isomers (HTDI or H₆TDI), 1-isocyanato-3,3,5-trimethyl-5-isocyanatomethylcyclohexane (=isophorone diisocyanate or IPDI), perhydrodiphenylmethane 2,4′- and 4,4′-diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethylxylylene 1,3- and 1,4-diisocyanate (m- and p-TMXDI) and bis(1-isocyanato-1-methylethyl)naphthalene, dimer and trimer fatty acid isocyanates such as 3,6-bis(9-isocyanatononyl)-4,5-di-(1-heptenyl)cyclohexene (dimeryl diisocyanate), and α,α,α′,α′,α″,α″-hexamethyl-1,3,5-mesitylene triisocyanate. Preference among these is given to MDI, TDI, HDI, and IPDI.

Suitable oligomers, polymers, and derivatives of the monomeric di- and triisocyanates mentioned are especially those derived from MDI, TDI, HDI, and IPDI. Particularly suitable among these are commercially available grades, especially HDI biurets such as Desmodur® N 100 and N 3200 (from Covestro), Tolonate® HDB and HDB-LV (from Vencorex), and Duranate® 24A-100 (from Asahi Kasei); HDI isocyanurates such as Desmodur® N 3300, N 3600, and N 3790 BA (all from Covestro), Tolonate® HDT, HDT-LV, and HDT-LV2 (from Vencorex), Duranate® TPA-100 and THA-100 (from Asahi Kasei), and Coronate® HX (from Nippon Polyurethane); HDI uretdiones such as Desmodur® N 3400 (from Covestro); HDI iminooxadiazinediones such as Desmodur® XP 2410 (from Covestro); HDI allophanates such as Desmodur® VP LS 2102 (from Covestro); IPDI isocyanurates, for example in solution as Desmodur® Z 4470 (from Covestro) or in solid form as Vestanat® T1890/100 (from Evonik); TDI oligomers such as Desmodur® IL (from Covestro); and also mixed isocyanurates based on TDI/HDI, for example as Desmodur® HL (from Covestro). Also particularly suitable are MDI forms that are liquid at room temperature (called “modified MDI”), which are mixtures of MDI with MDI derivatives such as, in particular, MDI carbodiimides or MDI uretonimines or MDI urethanes, known under trade names such as Desmodur® CD, Desmodur® PF, Desmodur® PC (all from Covestro) or Isonate® M 143 (from Dow), and mixtures of MDI and MDI homologs (polymeric MDI or PMDI), available under trade names such as Desmodur® VL, Desmodur® VL50, Desmodur® VL R10, Desmodur® VL R20, Desmodur® VH 20 N, and Desmodur® VKS 20F (all from Covestro), Isonate® M 309, Voranate® M 229 and Voranate® M 580 (all from Dow) or Lupranat® M 10 R (from BASF). The aforementioned oligomeric polyisocyanates are in practice typically mixtures of substances having different degrees of oligomerization and/or chemical structures. They preferably have an average NCO functionality of 2.1 to 4.0.

The polyisocyanate I is preferably selected from the group consisting of MDI, TDI, HDI, and IPDI, and oligomers, polymers, and derivatives of the isocyanates mentioned, and mixtures thereof.

The polyisocyanate preferably contains isocyanurate, iminooxadiazinedione, uretdione, biuret, allophanate, carbodiimide, uretonimine or oxadiazinetrione groups.

Particular preference as the polyisocyanate is given to MDI forms that are liquid at room temperature. These are especially what are called polymeric MDI, and MDI containing proportions of oligomers or derivatives thereof. The content of MDI (=diphenylmethane 4,4′-, 2,4′- or 2,2′-diisocyanate and any desired mixtures of these isomers) in such liquid MDI forms is in particular 50% to 95% by weight, in particular 60% to 90% by weight.

Particularly preference as the polyisocyanate is given to polymeric MDI and MDI grades that are liquid at room temperature and contain proportions of MDI carbodiimides or adducts thereof.

With these polyisocyanates, particularly good processing properties and particularly high strengths are obtained.

The polyisocyanate of the third component B may contain proportions of polyurethane polymers having isocyanate groups. Either the second component may include a polyurethane polymer having isocyanate groups that was produced separately, or the polyisocyanate has been mixed with at least one polyol, for example a polyol A as described above, in particular a polyether polyol, with the isocyanate groups present in a stoichiometric excess over the OH groups.

Component B preferably contains 50% to 100% by weight, especially 75% to 100% by weight, of polyisocyanate I, based on the third component B.

A preferred embodiment of a third component B contains, based on the overall component B,
50% to 100% by weight, especially 75% to 100% by weight, of polyisocyanate I,
and optionally further constituents.

Thus, the third component B, in some preferred embodiments, consists of polyisocyanate I. However, it is possible and may be advantageous for component B to additionally also include unreactive additives such as plasticizers and/or fillers. This may be advantageous when the mixing ratio is to be varied or the metered addition of small amounts is too inaccurate for process- or system-related reasons.

The composition according to the invention preferably includes polyisocyanate I in an amount of 10% by weight to 35% by weight, in particular of 15% by weight to 30% by weight, more preferably of 20% by weight to 25% by weight, based on the overall three-component composition.

### Further Constituents

In addition to the necessary constituents already mentioned, the polyurethane composition may include, in some or all components, further optional constituents as known to the person skilled in the art from multicomponent polyurethane chemistry. These may be present in just one component or in two components or in all components in the same or different amounts.

Preferred further constituents are inorganic or organic fillers, such as, in particular, natural, ground or precipitated calcium carbonates, optionally coated with fatty acids, in particular stearic acid, baryte (heavy spar), talcs, quartz powders, quartz sand, dolomites, wollastonites, kaolins, calcined kaolins, mica (potassium aluminum silicate), aluminum oxides, aluminum hydroxides, magnesium hydroxide, silicas including finely divided silicas from pyrolysis processes, industrially produced carbon blacks, graphite, metal powders such as aluminum, copper, iron, silver or steel, PVC powder or hollow spheres, and also flame-retardant fillers such as hydroxides or hydrates, in particular hydroxides or hydrates of aluminum, preferably aluminum hydroxide.

The addition of fillers is advantageous in that it increases the strength of the cured polyurethane composition.

The polyurethane composition preferably comprises at least one filler selected from the group consisting of calcium carbonate, carbon black, kaolin, fumed silica, baryte, talc, quartz powder, dolomite, wollastonite, kaolin, calcined kaolin, and mica. Particularly preferred as fillers are ground calcium carbonates and fumed silica. The latter additionally has a thickening effect and can increase thixotropy.

It may be advantageous to use a mixture of different fillers. Most preferred are combinations of ground calcium carbonates and fumed silica.

In preferred embodiments of the polyurethane composition of the invention, at least one of the two components A-1 and A-2 additionally includes at least one filler, preferably both components A-1 and A-2. This is preferably ground calcium carbonate and fumed silica. The use of fillers has the advantage that it is not only possible to formulate the composition less expensively, but it is also likewise possible to have a positive influence on mechanical properties, use properties such as the viscosity and thixotropy, and further properties such as electrical conductivity, thermal conductivity or combustibility.

The content of filler F in the composition is preferably within a range from 5% by weight to 70% by weight, especially 10% by weight to 65% by weight, more preferably 25% by weight to 60% by weight, based on the overall composition.

It is possible for further constituents to be additionally present, especially solvents, plasticizers and/or extenders, pigments, rheology modifiers such as, in particular, polyamide waxes and urea compounds, adhesion promoters such as, in particular, organofunctional trialkoxysilanes, stabilizers against oxidation, heat, light, and UV radiation, flame-retardant substances, and also surface-active substances, especially wetting agents and defoamers. All substances from the respective class that are commonly used in polyurethane chemistry are suitable for all these additives.

A preferred three-component polyurethane composition consists of a first component A-1 that contains, based in each case on the overall component A-1,
15% to 65% by weight, preferably 20% to 50% by weight, in particular 25% to 40% by weight, of polyol A,
1% to 5% by weight, preferably 1.25% to 4% by weight, especially 1.5% to 3.5% by weight, of a compound T having at least one thiol group, and
15% to 80% by weight, preferably 25% to 75% by weight, especially 50% to 70% by weight, of fillers,
and optionally further constituents;
   and
   a second component A-2 that contains, based in each case on the overall component A-2,
20% to 75% by weight, preferably 25% to 60% by weight, in particular 30% to 50% by weight, of polyol A,
0.05% to 1.0% by weight, preferably 0.1% to 0.75% by weight, especially 0.15% to 0.5% by weight, of metal catalyst K,
0.1% to 20% by weight, preferably 1% to 15% by weight, especially 5% to 12% by weight, of desiccant, and
10% to 75% by weight, preferably 25% to 70% by weight, especially 35% to 60% by weight, of fillers,
and optionally further constituents;
   and
   a third component B that contains, based on the overall component B,
50% to 100% by weight, especially 75% to 100% by weight, of polyisocyanate I,
and optionally further constituents.

The first component A-1, the second component A-2 and the third component B are advantageously formulated such that the mixing ratio thereof in parts by weight is in the range of A-1:A-2:B=100:(10-100):(10-100). This mixing ratio is preferably in the region of about 100:(50-100):(10-50), most preferably in the region of 100:100:(10-50).

In the mixed polyurethane composition, the ratio before curing between the number of isocyanate groups and the number of groups reactive toward isocyanates is preferably approximately within a range from 1.2 to 1, preferably 1.15 to 1.05. However, it is also possible, although not usually preferable, for the proportion of isocyanate groups to be substoichiometric with respect to groups reactive toward isocyanates.

The three components are produced separately and preferably with exclusion of moisture. The three individual components are typically each stored in a separate container. The further, optional constituents of the polyurethane composition may be present as a constituent of the first and/or second and/or third component, preferably with further constituents that are reactive toward isocyanate groups as a constituent of the first or second component. A suitable container for storage of the respective component is especially a vat, a hobbock, a bag, a bucket, a can, a cartridge or a tube. The components are all intrinsically storage-stable, meaning that they can be stored prior to use for several months up to one year or longer without any change in their respective properties to a degree relevant to their use. The three components are stored separately prior to the mixing of the composition and are not mixed with one another until use or just before use.

The sequence of mixing is unrestricted. It is possible to mix the components in any sequence, or to produce a preliminary mixture from two of the three components, into which the other component is then mixed. It is likewise possible to achieve mixing via simultaneous supply of all three components at the same time, for example to a static mixer. It is possible here for the individual components to be introduced at the same point in the mixer, or else at different points, in order that preliminary mixing of two components (for example A-1 and A-2) takes place before the other component is mixed in.

Mixing is typically effected via static mixers or with the aid of dynamic mixers. During mixing, care must be taken to ensure that the three components are mixed as homogeneously as possible. If the three components are mixed incompletely, local deviations from the advantageous mixing ratio will occur, which can result in a deterioration in the mechanical or other properties.

On contact of the first two components A-1 and A-2 with the third component B, curing commences through chemical reaction. This involves the reaction with the isocyanate groups of the hydroxyl groups and any other substances present that are reactive toward isocyanate groups. Excess isocyanate groups react predominantly with moisture. As a result of these reactions, the polyurethane composition cures to give a solid material. This process is also referred to as crosslinking.

The invention thus also further provides a cured polyurethane composition obtained from the curing of the polyurethane composition as described in the present document.

The three-component polyurethane composition described is advantageously usable as lamination adhesive, especially for the production of composite elements, for example for the building of truck trailers, or for the production of sandwich panels, for example for facade construction.

The invention further provides a method of adhesive bonding of at least one first substrate to at least one second substrate, comprising the following steps in the following sequence:
premixing the first component A-1 and the second component A-2 and subsequently mixing the third component B into the mixture of components A-1 and A-2, or
simultaneously mixing all three components A-1, A-2 and B,
applying the mixed polyurethane composition to at least one of the substrate surfaces to be bonded,
joining the substrates to be bonded within the open time,
optionally compressing the joined substrates,
curing the polyurethane composition.

These two substrates may consist of the same material or different materials. Suitable substrates in these methods of bonding are especially
glass, glass ceramic, glass mineral fiber mats;
metals and alloys such as aluminum, iron, steel and nonferrous metals, and also surface-finished metals and alloys such as galvanized or chromed metals;
coated and painted substrates, such as powder-coated metals or alloys and painted sheet metal;
plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), ethylene/propylene copolymers (EPM), and ethylene/propylene/diene terpolymers (EPDM), where the plastics may preferably have been surface-treated by means of plasma, corona or flames;
fiber-reinforced plastics, such as carbon fiber-reinforced plastics (CFRP), glass fiber-reinforced plastics (GFRP) and sheet-molding compounds (SMC);
foams, mineral wool mats, textiles or other insulation materials;
wood, woodbase materials bonded with resins, for example phenolic, melamine or epoxy resins, resin-textile composites and further polymer composites; and
concrete, mortar, brick, plaster, and natural stone such as granite, limestone, sandstone or marble.

In these methods, one or both substrates is preferably a metal or a glass fiber-reinforced plastic or a carbon fiber-reinforced plastic or a plastic. The substrates can be pretreated if required prior to the application of the composition. Pretreatments of this kind especially include physical and/or chemical cleaning methods, and the application of an adhesion promoter, an adhesion promoter solution, an activator or a primer.

The composition of the invention is preferably applied in mixed form to the entirety of a substrate area, especially with a layer thickness of between 100 μm and 2.5 mm.

The adhesive bonding process described gives rise to an article in which the composition joins two substrates to one another.

Said article is especially a sandwich element of a lightweight structure, an industrial good or a consumer good, especially a composite panel or a means of transport, especially a vehicle, preferably an automobile, a bus, a truck, a rail vehicle or a ship, or else an aircraft or a helicopter, or an installable component of such an article.

The polyurethane composition described is characterized by high strength and elasticity that is highly constant over a wide temperature range from −35° C. to 85° C. and by good, largely temperature-independent adhesion properties on metallic substrates. Because of these properties, it is of very particular suitability as lamination adhesive for adhesive bonds that can be implemented at ambient temperatures in regions with fluctuating relative humidity.

A further aspect of the invention is the use of a three-component polyurethane composition as described above as lamination adhesive for bonding of at least two substrates.

Preference is given to use for production of composite sheets, especially for truck and trailer building, and sandwich elements, especially insulation panels for facade construction.

The invention is further elucidated hereinafter by examples, but these are not intended to restrict the invention in any way.

### EXAMPLES

### Substances Used:

The table below lists the substances that were used in the example compositions. The raw materials were used as purchased without further treatment.

| | |
|---|---|
| Voranol CP 4755 | Voranol ® CP 4755 (Dow Chemical); polyether triol; |
| | Mw: 5000 g/mol; OH number: 35 mg KOH/g |
| Voranol CP 450 | Voranol ® CP 450 (Dow Chemical); polyether triol; |
| | Mw: 439 g/mol; OH number: 383 mg KOH/g |
| Setathane D 1150 | Setathane ® D 1150 (Allnex); castor oil-based, |
| | branched polyol; OH content: 4.7% (DIN 53 240-2) |
| Pentane-1,5-diol | (Sigma Aldrich) |
| Thiocure TMPMP | Thiocure ® TMPMP (Bruno Bock Thiochemicals); |
| | trimethylolpropane tri(3-mercaptopropionate) |
| Desmodur VK 10 | Desmodur ® VK 10 (Covestro); mixture of diphenyl- |
| | methane 4,4′-diisocyanate (MDI) with isomers |
| | and higher-functionality homologs (PMDI). NCO |
| | content: 31.5% by weight |
| Omyacarb 10-GU | Omyacarb ® 10-GU (Omya); ground chalk (filler) |
| Cab-O-Sil M5 | Cab-O-Sil ® M-5 (Cabot); untreated fumed silica |
| | (filler/thixotropic agent) |
| Sylosiv A 3 | Sylosiv ® A 3 (Grace); micronized, porous, crystalline |
| | aluminosilicate (molecular sieve) having pore sizes of |
| | about 3 Å (desiccant) |
| TIB KAT 318 | TIB KAT ® 318 (TIB Chemicals); dioctyltin |
| | dicarboxylate (CAS No.: 68299-15-0); organotin(IV) |
| | catalyst |
| Coscat 83 | Coscat ® 83 (Vertellus Specialties Inc.); |
| | organobismuth catalyst for two-component |
| | polyurethane compositions |

### Production of Polyurethane Compositions

For each composition, the ingredients of the first component A-1 specified in tables 1 to 3 were processed in the specified amounts (in parts by weight or % by weight), by means of a vacuum dissolver with the exclusion of moisture, to give a homogeneous paste and stored under airtight seal. The ingredients of the second component A-2 and of the third component B specified in the tables were likewise processed and stored, and also the first component A and the second component B in the case of reference example 1.

The pot life, open time and pressing time of the example compositions were measured. The details of the measurements are described below. All three measurement protocols were conducted for all samples once at 23° C. and 50% relative humidity and once at 23° C. and 70% relative humidity. It is thus possible to establish the influence of humidity.

Pot life was measured by first successively introducing the three or two components of the multicomponent polyurethane composition to be examined (first A-1, then A-2, which were first premixed, and finally B in the case of the three-component samples, or first A, then B, in the case of the two-component reference sample), these having been equilibrated beforehand at 23° C. for at least 3 h, into a 130 mL polypropylene cup, and then using a hand blender to homogenize them immediately over the course of 30 seconds. 100 g of this mixed composition was transferred into a further cup and left to stand. By means of a stopwatch that was started after stirring, the time was measured constantly. A laboratory spatula was used, at intervals of not more than 30 seconds, to check whether the composition had started to cure. For this purpose, the mixture was raised with the spatula and it was checked whether it still drips off in liquid form or has already thickened and forms threads. As soon as noticeable threading and an increase in viscosity in the form of curing of the core of the mixture had been detected, the measurement was stopped and the time was noted. This constitutes the pot life.

Open time was measured by first successively introducing three or two components of the multicomponent polyurethane composition to be examined (first A-1, then A-2, which were first premixed, and finally B in the case of the three-component samples, or first A, then B, in the case of the two-component reference sample), these having been equilibrated beforehand at 23° C. for at least 3 h, into a 130 mL polypropylene cup (the amounts were chosen so as to result in about 100 g of mixed composition), and then using a hand blender to homogenize them immediately over the course of 30 seconds. By means of a stopwatch that was started after stirring, the time was measured constantly. The mixed composition was applied to an A4-sized metal plate and spread by means of a toothed smoothing trowel. The smoothing trowel had square cutouts (2 mm×2 mm) at 10 mm intervals on the edge of the smoothing trowel. This was used to produce a uniform coating of polyurethane composition on the plate, which was in stripey form as a result of the toothed smoothing trowel. After about half of the expected open time, a rectangular glass body (L×W×H=75 mm×25 mm×5 mm) was applied to the composition that had been applied in stripes, with the length of the glass body at right angles to the polyurethane stripes. A weight of mass 1 kg was then applied to the glass body, resulting in a uniform weight distribution over the entire glass surface area, and the time was noted. It was possible to observe through the glass that the underlying polyurethane stripes were pressed and smoothed. At defined time intervals of not more than one minute, further identical glass bodies were applied successively to the polyurethane stripes and weighted down with weights. As soon as no further smoothing of the polyurethane stripes beneath was detectable as a result of the progressive curing, the measurement was stopped and the time was noted. The open time was determined as the last measure time after which a glass body weighted down in this way was still able to press the polyurethane stripes beneath to a uniform, uninterrupted film.

Press time was measured by the following method: First of all, an aluminum test plate (L×W×H=250 mm×80 mm×3 mm) was degreased and cleaned with a hydrocarbon-based cleaning agent (Sika® Remover-208, Sika Deutschland), then roughened with sandpaper (roughness 150), and then cleaned again (Sika® Remover-208, Sika Deutschland). Thereafter, aluminum pull tabs with a circular, flat base (diameter 20 mm) were provided. These pull tabs were cleaned and prepared on the underside (base) in the same way as the test plate. Subsequently, the compositions to be tested were produced by first successively introducing the three or two components of the multicomponent polyurethane composition to be examined (first A-1, then A-2, which were first premixed, and finally B in the case of the three-component samples, or first A, then B, in the case of the two-component reference sample), these having been equilibrated beforehand at 23° C. for at least 3 h, into a 130 mL polypropylene cup (the amounts were chosen so as to result in about 100 g of mixed composition), and then using a hand blender to homogenize them immediately over the course of 30 seconds.

The mixed composition was applied immediately to the test plate by means of a doctor blade (with a fixed gap of 300 micrometers) with a uniform layer height (0.3 mm). 20 of the above-described pull tabs were applied to this applied composition and pressed on firmly. The distance between the individual pull tabs was at least 15 mm. A weight of mass 1 kg was placed on top of every two of these pull tabs. By means of a stopwatch that was started after the weighting-down with the weights, the time was measured constantly. As soon as the curing of the polyurethane coating applied had advanced noticeably, the process of pulling off the individual pull tabs successively by means of a tensile adhesion tester (PosiTest® AT-A, DeFelsko, USA) at 1 MPa per second was commenced, and the force required for the purpose and the time elapsed were noted. The time interval between the individual measurements was 1 minute. The time until a required tensile force of 1 MPa arose was fixed as the pressing time. This time defines how long a composite element that has been bonded with a particular polyurethane composition has to be pressed before the adhesion force between the bonded substrate layers is at least 1 MPa.

TABLE 1
Three-component composition Example 1.

| Example 1 | Components | | |
|---|---|---|---|
| Numbers in parts by weight | A-1 | A-2 | B |
| Setathane D 1150 | 13 | 17 | — |
| Voranol CP 450 | 15 | 15 | — |
| Omyacarb 10-GU | 68.5 | 57.3 | — |
| Cab-O-Sil M5 | 0.5 | 0.5 | — |
| Thiocure TMPMP | 3 | — | — |
| Sylosiv A 3 | — | 10 | — |
| TIB KAT 318 | — | 0.2 | — |
| Desmodur VK 10 | — | — | 100 |
| TOTAL | 100 | 100 | 100 |
| Mixing ratio (w/w/w) | 1 | 1 | 0.207 |
| A-1:A-2:B = 1:1:0.207 | | | |

TABLE 2
Three-component composition Example 2.

| Example 2 | Components | | |
|---|---|---|---|
| Numbers in parts by weight | A-1 | A-2 | B |
| Setathane D 1150 | 13 | 17 | — |
| Voranol CP 450 | 15 | 15 | — |
| Omyacarb 10-GU | 68 | 56.5 | — |
| Cab-O-Sil M5 | 1 | 1 | — |
| Thiocure TMPMP | 3 | — | — |
| Sylosiv A 3 | — | 10 | — |
| TIB KAT 318 | — | 0.5 | — |
| Desmodur VK 10 | — | — | 100 |
| TOTAL | 100 | 100 | 100 |
| Mixing ratio (w/w/w) | 1 | 1 | 0.207 |
| A-1:A-2:B = 1:1:0.207 | | | |

TABLE 3
Two-component composition Reference example 1.

| | |
|---|---|
| Reference example 1 | Components |

| Numbers in parts by weight | A | B |
|---|---|---|
| Voranol CP 4755 | 27.55 | — |
| Pentane-1,5-diol | 6 | — |
| Thiocure TMPMP | 3 | — |
| Coscat 83 | 0.45 | — |
| Omyacarb 10-GU | 63 | — |
| Desmodur VK 10 | — | 100 |
| TOTAL | 100 | 100 |
| Mixing ratio (w/w) | 1 | 0.23 |
| A:B = 1:0.23 | | |

Tables 1 to 3 show the formulations of the three- or two-component compositions tested (in parts by weight, with individual listing of the specific components).

The formulations shown in tables 1 and 2 are three-component polyurethane compositions of the invention. They differ primarily in the amount of catalyst present.

Table 3, by comparison, shows a noninventive two-component polyurethane composition that corresponds to the prior art (especially WO 2019/002538 A1).

Table 4 below shows the results of the above-described measurements. In particular, in this test series, the influence of the humidity was examined in a typical application as lamination adhesive for the production of composite elements. For these, the test of pressing time in particular is important since the large-area, thin-layer application of the lamination adhesive in the pressing time test simulates the production of two-dimensional composite elements.

TABLE 4
Results of the measurements of pot life, open time and
pressing time of the respective tested adhesives.

| | Example 1 | | Example 2 | | Reference example 1 | |
|---|---|---|---|---|---|---|
| | Relative humidity | | | | | |
| | 23° C. | 23° C. | 23° C. | 23° C. | 23° C. | 23° C. |
| | 50% r.h. | 70% r.h. | 50% r.h. | 70% r.h. | 50% r.h. | 70% r.h. |
| Pot life | 7 min 30 s | 7 min 30 s | 5 min 40 s | 5 min 40 s | 5 min 40 s | 5 min 40 s |
| Open time | 14 min | 14 min | 10 min | 10 min | 17 min | 17 min |
| Pressing time | 34 min | 34 min | 21 min | 21 min | 30 min | 50 min * |
| (up to tensile | | | | | | |
| force 1 MPa) | | | | | | |

* after 30 min , a tensile force of only 0.21 MPa was measured.

The results in table 4 show clearly that the compositions of the invention are absolutely not influenced by humidity and cure and build up adhesion in an identical manner even in the case of elevated relative humidity. Furthermore, the data show that the amount of catalyst (or the ratio of catalyst to compound T) influences pot life, and also open time and pressing time, and can be adjusted if required.

The reference composition has no sensitivity to elevated humidity with regard to pot life and open time in the measurements conducted. However, a distinct influence is apparent in the measurement of pressing time, and the composition loses its ability to rapidly build up adhesion at elevated relative humidity. Specifically this test is an important examination to ascertain suitability as lamination adhesive, for example in the production of composite elements.

### Storage Stability Tests

The respective three or two components of the example 1, example 2 and reference example 1 compositions were subjected to a simulated aging process. For this purpose, the closed containers of the respective components were stored in a heating cabinet at 40° C. After heated storage for 1, 2, 3, 4 or 8 weeks, the respective components of the respective composition were removed and equilibrated at 23° C. for 24 h. Thereafter, the same test programs as described above for pot life, open time and pressing time were conducted. The results are shown in tables 5 to 7 below.

The results from tables 5 to 7 show that the inventive example 1 and example 2 compositions are extremely storage-stable and their properties do not change even after prolonged heated storage.

By contrast, the prior art reference composition shows a distinct change in all the properties measured.

TABLE 5
Results of the measurements of pot life, open time and pressing
time of example 1 after heated storage (simulated aging).

| | Example 1 | | | | | |
|---|---|---|---|---|---|---|
| | Relative humidity | | | | | |
| | 23° C. | | | | | |
| | 50% r.h. | | | | | |
| | Storage | | | | | |
| | | 1 week | 2 weeks | 3 weeks | 4 weeks | 8 weeks |
| | fresh | 40° C. | 40° C. | 40° C. | 40° C. | 40° C. |
| Pot life | 7 min 30 s | 7 min 35 s | 7 min 40 s | 7 min 40 s | 7 min 25 s | 7 min 40 s |
| Open time | 14 min | 14 min 30 s | 14 min 30 s | 14 min 30 s | 14 min 30 s | 14 min 30 s |
| Pressing time | 34 min | 32 min | 33 min | 33 min | 32 min | 32 min |
| (up to tensile | | | | | | |
| force 1 MPa) | | | | | | |

TABLE 6
Results of the measurements of pot life, open time and pressing
time of example 2 after heated storage (simulated aging).

| | Example 2 | | | | | |
|---|---|---|---|---|---|---|
| | Relative humidity | | | | | |
| | 23° C. | | | | | |
| | 50% r.h. | | | | | |
| | Storage | | | | | |
| | | 1 week | 2 weeks | 3 weeks | 4 weeks | 8 weeks |
| | fresh | 40° C. | 40° C. | 40° C. | 40° C. | 40° C. |
| Pot life | 5 min 40 s | 5 min 35 s | 5 min 45 s | 5 min 45 s | 5 min 50 s | 5 min 35 s |
| Open time | 10 min | 10 min | 10 min | 10 min | 9 min 45 s | 9 min 30 s |
| Pressing time | 21 min | 20 min 30 s | 21 min | 20 min 30 s | 20 min 30 s | 20 min |
| (up to tensile | | | | | | |
| force 1 MPa) | | | | | | |

TABLE 7
Results of the measurements of pot life, open time and pressing time
of reference example 1 after heated storage (simulated aging).

| | Reference example 1 | | | | | |
|---|---|---|---|---|---|---|
| | Relative humidity | | | | | |
| | 23° C. | | | | | |
| | 50% r.h. | | | | | |
| | Storage | | | | | |
| | | 1 week | 2 weeks | 3 weeks | 4 weeks | 8 weeks |
| | fresh | 40° C. | 40° C. | 40° C. | 40° C. | 40° C. |
| Pot life | 5 min 40 s | 5 min | 5 min 30 s | 6 min | 6 min 30 s | 7 min 45 s |
| Open time | 17 min | 15 min | 16 min 30 s | 21 min | 24 min | 35 min |
| Pressing time | 30 min | 26 min | 31 min | 37 min | 49 min | 63 min |
| (up to tensile | | | | | | |
| force 1 MPa) | | | | | | |

1. A polyurethane composition suitable as lamination adhesive, consisting of three components to be mixed on use; wherein
the first component A-1 comprises
at least one polyol A having an OH functionality in the range from 1.5 to 4 and an average molecular weight (number average) Mₙ in the range from 250 to 15 000 g/mol, and
at least one compound T that has at least one thiol group; and
the second component A-2 comprises
at least one metal catalyst K for the reaction of hydroxyl groups and isocyanate groups that can form thio complexes; and
the third component B comprises
at least one polyisocyanate I;
where the molar ratio of all thiol groups in the at least one compound T to all metal atoms in the at least one metal catalyst K is between 1:1 and 250:1.

2. The polyurethane composition as claimed in claim 1, wherein the metal catalyst K comprises a tin(IV) compound.

3. The polyurethane composition as claimed in claim 2, wherein the tin(IV) compound is a dioctyltin dicarboxylate.

4. The polyurethane composition as claimed in claim 1, wherein component A-2 additionally includes at least one polyol A.

5. The polyurethane composition as claimed in claim 1, wherein the at least one compound T comprises a polythiol compound having 2 to 6 thiol groups, or a mercaptosilane.

6. The polyurethane composition as claimed in claim 5, wherein the at least one compound T is selected from the group consisting of ethylene glycol di(3-mercaptopropionate), ethylene glycol dimercaptoacetate, dipentaerythritol hexa(3-mercaptopropionate), trimethylolpropane tri(3-mercaptopropionate) and 3-mercaptopropyltrimethoxysilane.

7. The polyurethane composition as claimed in claim 1, wherein the molar ratio of all the thiol groups in the at least one compound T to all metal atoms in the at least one metal catalyst K is between 5:1 and 100:1.

8. The polyurethane composition as claimed in claim 1, wherein at least one of the two components A-1 and A-2 includes a filler.

9. The polyurethane composition as claimed in claim 1, wherein the polyol A comprises at least one polyether triol.

10. The polyurethane composition as claimed in claim 1, wherein the polyisocyanate I is a form of diphenylmethane 4,4′-, 2,4′- or 2,2′-diisocyanate that is liquid at room temperature or any desired mixtures of these isomers (MDI) in the form of polymeric MDI or MDI containing proportions of oligomers or derivatives, in particular carbodiimides.

11. The polyurethane composition as claimed in claim 1, wherein the third component B comprises a polyurethane polymer containing isocyanate groups.

12. A method of adhesive bonding of at least one first substrate to at least one second substrate, comprising the following steps in the following sequence:
premixing the first component A-1 and the second component A-2 and subsequently mixing the third component B into the mixture of components A-1 and A-2, or
simultaneously mixing all three components A-1, A-2 and B of a three-component polyurethane composition as claimed in claim 1,
applying the mixed polyurethane composition to at least one of the substrate surfaces to be bonded,
joining the substrates to be bonded within the open time,
optionally compressing the joined substrates,
curing the polyurethane composition.

13. An article resulting from the adhesive bonding method as claimed in claim 12.

14. A method comprising applying a polyurethane composition as claimed in claim 1 as lamination adhesive for the bonding of at least two substrates.

15. The method of claim 14 for production of composite panels.
